(19) United States
(12) Patent Application Publication
(10) Pub. No.: US 2023/0185533 A1
(43) Pub. Date: Jun. 15, 2023

(54) CONFIGURABLE NONLINEAR ACTIVATION FUNCTION CIRCUITS

(71) Applicant: QUALCOMM Incorporated, San Diego, CA (US)

(72) Inventors: Ren LI, San Diego, CA (US); Prajakt KULKARNI, San Diego, CA (US); Suren MOHAN, San Diego, CA (US); Aaron Douglass LAMB, San Diego, CA (US)

(21) Appl. No.: 18/165,802

(22) Filed: Feb. 7, 2023

Related U.S. Application Data
(63) Continuation-in-part of application No. 17/467,079, filed on Sep. 3, 2021.

(51) Int. Cl. G06F 7/556; G06F 7/50

(52) U.S. Cl. CPC G06F 7/556; G06F 7/50

(57) ABSTRACT

Certain aspects of the present disclosure provide a method for processing input data by a set of configurable nonlinear activation function circuits, including generating an exponent output by processing input data using one or more first configurable nonlinear activation function circuits configured to perform an exponential function, summing the exponent output of the one or more first configurable nonlinear activation function circuits, and generating an approximated log softmax output by processing the summed exponent output using a second configurable nonlinear activation function circuit configured to perform a natural logarithm function.

### CROSS-REFERENCE TO RELATED APPLICATIONS

This Application is a continuation-in-part of U.S. Pat. Application No. 17/467,079, filed on Sep. 3, 2021, the entire contents of which are incorporated herein by reference.

### INTRODUCTION

Aspects of the present disclosure relate processing nonlinear activation functions for machine learning models, and in particular to configurable nonlinear activation function circuits.

Machine learning is generally the process of producing a trained model (e.g., an artificial neural network), which represents a generalized fit to a set of training data. Applying the trained model to new data enables production of inferences, which may be used to gain insights into the new data.

As the use of machine learning has proliferated for enabling various machine learning (or artificial intelligence) tasks, the need for more efficient processing of machine learning model data has arisen. In some cases, dedicated hardware, such as machine learning (or artificial intelligence) accelerators or processors or similar circuits, may be used to enhance a processing system’s capacity to process machine learning model data. For example, processing data with a nonlinear activation function may be distributed to a processor other than the primary matrix multiplication processor. However, distributing various aspects of processing a machine learning model across different processing devices may incur latency, memory use, power use, and other processing penalties.

Accordingly, there is a need for improved techniques for processing machine learning model data with nonlinear activation functions.

### BRIEF SUMMARY

Certain aspects provide a processor, comprising: one or more first configurable nonlinear activation function circuits configured to perform an exponential function on input data; a summation circuit configured to receive output data of the one or more first configurable nonlinear activation function circuits; and a second configurable nonlinear activation function circuit configured to receive output data of the summation circuit, perform a natural logarithm function, and output an approximated log softmax of the input data.

Further aspects provide a method for processing input data by a set of configurable nonlinear activation function circuits, comprising: generating an exponent output by processing input data using one or more first configurable nonlinear activation function circuits configured to perform an exponential function; summing the exponent output of the one or more first configurable nonlinear activation function circuits; and generating an approximated log softmax output by processing the summed exponent output using a second configurable nonlinear activation function circuit configured to perform a natural logarithm function.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the one or more aspects and are therefore not to be considered limiting of the scope of this disclosure.

FIG. 1 depicts an example configurable nonlinear activation (CNLA) function circuit.

FIG. 2 depicts example circuit blocks for implementing bypassable approximator blocks, such as described with respect to FIG. 1.

FIG. 3 depicts an example approximator.

FIG. 4 depicts an example machine learning model process flow.

FIG. 5 depicts an example method for performing processing using a configurable nonlinear activation function circuit.

FIG. 6 depicts an example architecture of CNLA function circuits to perform softmax operations using parallel input data.

FIG. 7 depicts an example architecture of CNLA function circuits to perform softmax operations using sequential input data.

FIG. 8 depicts an example method for performing approximated softmax operations using a CNLA function circuit.

FIG. 9 depicts an example processing system that may be configured to perform the methods described herein.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide improved techniques for processing nonlinear activation functions associated with machine learning models.

Nonlinear activations are key components of various types of machine learning models, including neural network models. While some nonlinear activation functions are implemented as piecewise linear functions (e.g., rectified linear unit (ReLU), leaky ReLU, and others), other nonlinear activations functions require complex mathematical functions (e.g., sigmoid, hyperbolic tangent (tanh), and others). In some cases, the complex mathematical functions may be implemented using interpolation, such as cubic spline interpolation. For example, an interpolated output value may be determined in some aspects using a look-up table (LUT) to match output values with input values. When a target input value is not mapped in the LUT, LUT values associated with input values adjacent to the target input value may be used to interpolate an output value for the target input value.

Conventionally, nonlinear activation functions may be implemented in software rather than hardware owing to the wide range of possible activation functions usable in machine learning models. However, such implementations typically require moving model data between processing devices (e.g., between a neural processing unit (NPU) performing matrix multiplication and accumulation and a digital signal processor (DSP) processing the nonlinear activation function), thus incurring power and latency penalties. Where nonlinear activation functions have been implemented in hardware, they have generally been limited to supporting only a small number of nonlinear activation functions and thus cannot be configured to support evolving machine learning model architectures without falling back to outsourcing the nonlinear activation function processing to other processing units.

For example, the rectified linear unit (ReLU) is a commonly used activation function in deep learning models. The function returns 0 if it receives a negative input, and returns the input, x, otherwise. Thus it can be written as ƒ(x) = max(0,x). ReLU functions are generally not implemented by the primary matrix multiplication and accumulation processing unit, such as a compute-in-memory (CIM) array in some examples. Thus, the need to distribute the ReLU function, or another nonlinear activation function, may be costly from a processing standpoint. Moreover, as the activation function gets more complex, the processing cost likewise gets more significant (e.g., for performing relatively higher power exponential and division operations that are part of certain nonlinear activation functions, as described further below).

To overcome the shortcomings of conventional solutions, aspects described herein relate to a configurable nonlinear activation (CNLA) function circuit that may be implemented in hardware for efficient processing. In particular, because it can be implemented in hardware, the CNLA function may be co-located with other processing circuits optimized for other machine learning model processing tasks, such as CIM arrays and digital multiply-and-accumulate (DMAC) circuits that are optimized for performing vector and matrix multiplication and accumulation functions.

In order to improve processing efficiency, aspects described herein may use polynomial approximations to approximate complex functions, such as may be used within nonlinear activation functions. In some cases, aspects described herein may use series expansions, such as a Taylor series. Generally, a Taylor series of a function (e.g., ƒ(x)) is an infinite sum of terms that are expressed in terms of the function’s derivatives at a single point. For many functions, the function and the sum of its Taylor series are equal near this point. The partial sum formed by the first n + 1 terms of a Taylor series is a polynomial of degree n that is referred to as the nth Taylor polynomial of the function. Thus, Taylor polynomials allow for processing efficient approximations of a function, which generally become better as n increases.

The CNLA function circuits described herein may implement one or more polynomial approximation blocks, such as cubic approximation blocks, which generally enhance cubic spline interpolation to make it more efficient and more generalized to cover a wider variety of nonlinear activation functions. Moreover, the CNLA function circuits may be implemented as a pipelined digital block that can use nonlinearly segmented look-up tables (LUTs) and mixed orders of approximations (e.g., pipelined linear, quadratic, and cubic approximations). Thus, the CNLA function circuits described herein can be configured to meet many different performance goals, unlike conventional nonlinear activation function circuits.

Accordingly, the CNLA function circuits described herein provide a technical solution to the technical problem of implementing a wide range of nonlinear activation functions in machine learning model processing systems. Further, the CNLA function circuits described herein provide a technical improvement by way of increased model processing performance compared to existing solutions, including lower latency, lower power use, improved memory efficiency, and others as described herein.

### Example Configurable Nonlinear Activation Function Circuit

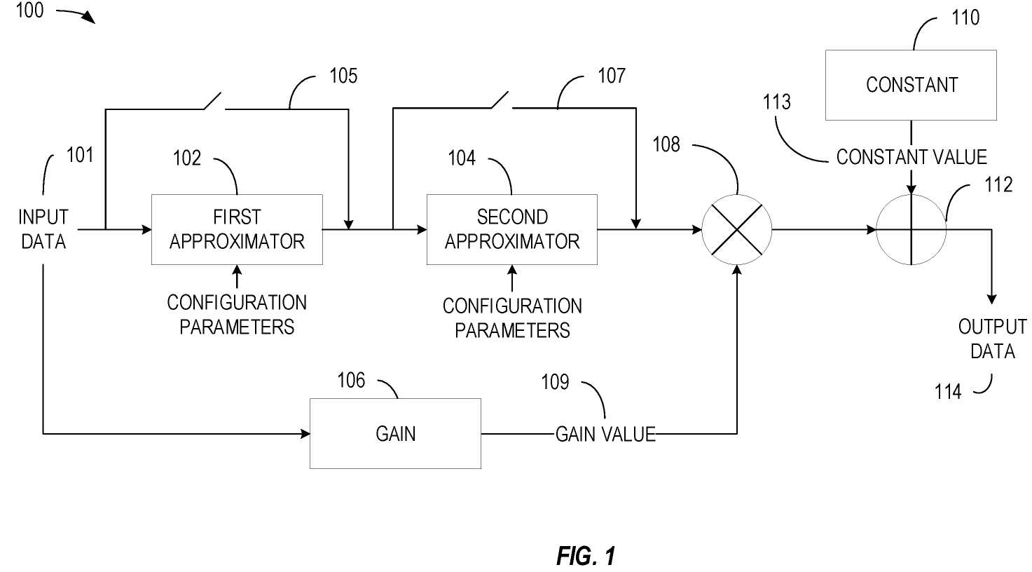

FIG. 1 depicts an example configurable nonlinear activation (CNLA) function circuit 100.

Generally, CNLA function circuit 100 may be configured to receive input data 101 (e.g., an output value from a layer of a machine learning model) and to perform various nonlinear activation functions to generate output data 114 (e.g., “activations”). CNLA function circuit 100 may be co-located and pipelined with other machine learning model processing circuits, such as a CIM array, DMAC, and others, and may be configured to perform activation functions based on the output of the other machine learning model processing circuits.

In some examples, input data 101 may be received from a buffer or other memory. In other examples, input data 101 may be received directly from the output of another processing block, such as the output of a CIM array or another vector and matrix multiplication and accumulation block, or the like.

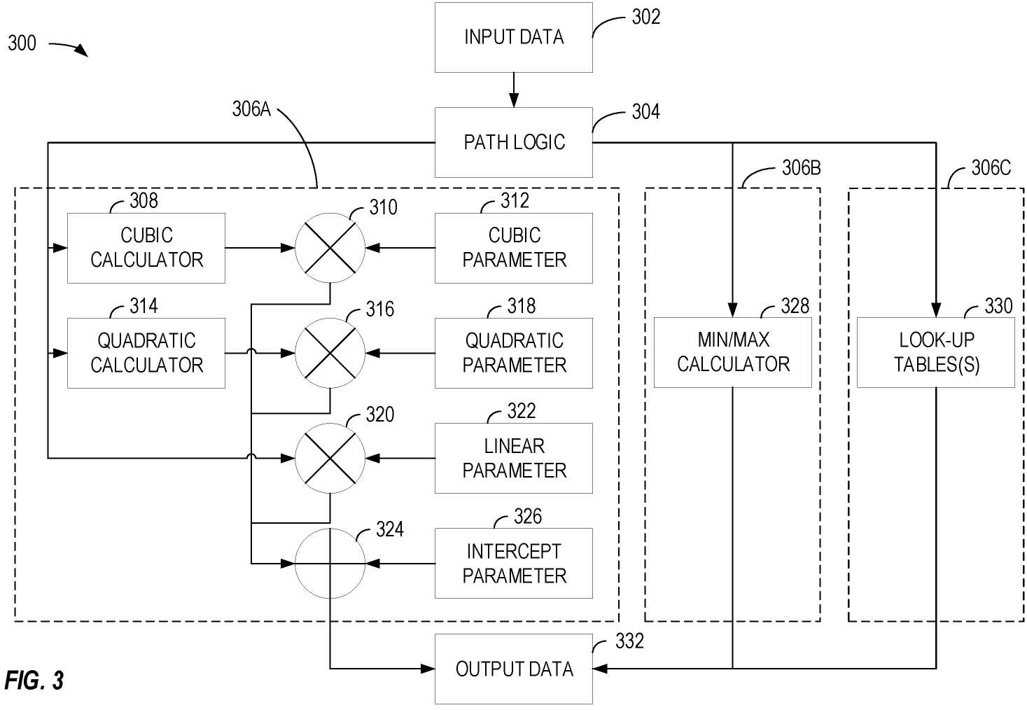

CNLA function circuit 100 includes a first approximator block 102, which may generally be configured to perform a hardware-based mathematical function, such as on input data 101. An example approximator is described in detail with respect to FIG. 3.

In some cases, first approximator is one of a linear approximator (e.g., configured to perform a linear function, such as ax + b), a quadratic approximator (e.g., configured to perform a quadratic function, such as ax² + bx + c ), or a cubic approximator (e.g., configured to perform a cubic function, such as ax³ + bx² + cx + d), where x is the input data and a, b, c, and d are configurable parameters. Generally, a linear, quadratic, or cubic approximator may be used to approximate some given function, which may or may not be a polynomial function. First approximator 102 may be configured with parameters, retrieved from, for example, a memory, a register, a look-up table, or the like. As described in further detail below with respect to Table 2 below, these different forms of approximation and associated configurable parameters can be used to approximate many types of nonlinear activation functions.

CNLA function circuit 100 further includes a second approximator block 104, which, like first approximator block 102, may generally be configured to perform a hardware-based mathematical function, such as a linear, quadratic, or cubic function. As described in more detail below, CNLA function circuit 100 may be configured to use first approximator block 102 and second approximator block 104 in series for more complex functions, such that the output of first approximator block 102 becomes an input to second approximator block 104. CNLA function circuit 100 may be further configured to use only one of first approximator block 102 or second approximator block 104 when a simpler nonlinear function is being processed, thereby saving power.

In some implementations, first approximator 102 and second approximator 104 may comprise the same circuit block (e.g., two instances of the same circuit elements within circuit 100). For example, first approximator 102 and second approximator 104 may comprise cubic approximators in some aspects. In other implementations, first approximator 102 and second approximator 104 may comprise different circuit elements, and in such cases, generally second approximator 104 will comprise a cubic approximator and first approximator 102 will comprise a lower order approximator, such as a quadratic or linear approximator. However, in other aspects, the order of the higher and lower order approximators may be reversed.

CNLA function circuit 100 includes a configurable bypass 105, which allows first approximator 102 to be bypassed in various scenarios, such as if a function only requires a lower order approximator than first approximator 102 and second approximator 104 is such a lower order approximator. When, for example, first approximator 102 is bypassed via configurable bypass 105, then input data 101 is provided directly to second approximator 104 instead and not processed by first approximator 102. In various aspects, first approximator 102 may be a higher order approximator compared to second approximator 104, or vice versa, or they may be of the same order (e.g., both linear, quadratic, or cubic). The configurable bypass 105 allows for saving processing time and energy when only one approximator is necessary.

CNLA function circuit 100 further includes another configurable bypass 107, which allows second approximator 104 to be bypassed in various scenarios, such as if a function only requires a first approximation, which first approximator 102 is capable of performing without second approximator 104. When, for example, second approximator 104 is bypassed via configurable bypass 107, the output of first approximator 102 is provided directly to multiplier 108.

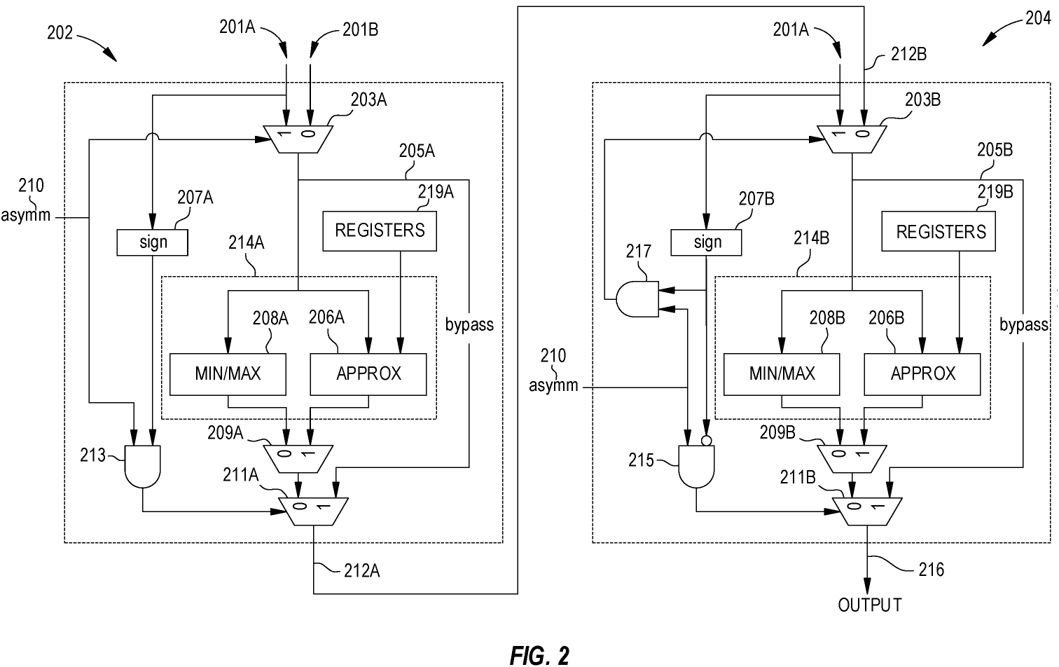

Generally, configurable bypasses 105 and 107 allow CNLA function circuit 100 to be configured for maximum versatility, while saving power and avoiding unnecessary circuit block processing in various scenarios. Further, configurable bypasses allow for non-symmetric and anti-symmetric nonlinear activation functions to be configured for processing by CNLA function circuit 100. FIG. 2 depicts example circuit aspects for implementing configurable bypasses 105 and 107 (e.g., bypasses 205A and 205B).

CNLA function circuit 100 further includes a gain block 106 configured to provide a gain value to multiplier 108. In some aspects, gain block 106 is configured to generate a gain value 109 based on a gain function implemented by gain block 106. In one example, the gain function may be in the form g = ax + b, where g is the gain value, x is the input data 101 value, and a and b are configurable parameters. More generally, the gain block 106 may modify the input data multiplicatively (a) and/or additively (b) to generate the gain value.

The gain value 109 generated by gain block 106 is multiplied with the output of first and/or second approximators 102 and 104 via multiplier 108. In other aspects, gain block 106 may be configured with a gain value that is not based on a function of input data 101 (e.g., by setting a to zero in the above expression for g). Generally, the parameters (e.g., a and b in the example above) or value for gain block 106 may be retrieved from, for example, a memory, a register, a look-up table, or the like.

CNLA function circuit 100 further includes a constant block 110 configured to store a configurable (e.g., programmable) constant value 113 and adder 112 configured to add the constant value 113 to the output of multiplier 108 (e.g., a gain multiplier). The constant value 113 stored in constant block 110 may be retrieved from, for example, a memory, a register, a look-up table, or the like.

The inclusion and arrangement of first approximator block 102, second approximator block 104, configurable bypasses 105 and 107, gain block 106, multiplier 108, constant block 110, and adder 112 allows for CNLA function circuit 100 to be configured to perform a wide variety of known and later developed nonlinear activation functions. Moreover, CNLA function circuit 100 may be efficiently configured to process a wide variety of nonlinear activation functions by merely updating parameters for the first approximator 102, second approximator 104, gain block 106, and constant block 110. When both approximator blocks 102 and 104 are collectively used to simulate a nonlinear function, each approximator block 102 and 104 may be referred to as performing a corresponding individual function (e.g., a first function performed by the first approximator block 102 and a second function performed by the second approximator 104). This design beneficially supports arbitrary non-symmetric nonlinear curves for complex functions.

Table 1, below, provides example parameters for various nonlinear activation functions that CNLA function circuit 100 of FIG. 1 can be configured to perform, including parameters for approximator blocks 206A and 206B of FIG. 2. In Table 1, the gain is considered to have the form ax + b, as is in the example of gain block 106 in FIG. 1, but note that in other aspects, the gain may be a scalar value, or a different functional form. Similarly, a quadratic approximator is considered to have the form ax² + bx + c and a cubic approximator is considered to have the form ax³ + bx² + cx + d. In the following table, subscripts are used to indicate parameter assignments, e.g., G for gain parameters, 1 for first approximator, and 2 for second approximator parameters.

TABLE 1

| | | |
|---|---|---|
| Nonlinear Activation Function | Form | Parameters |
| ReLU | ReLU(x) = max(0,x) | Asymmetric = 0 Gain: (a_{G} = 0, b_{G} = 1) Constant = 0 First Approximator ➔ quadratic parameters { a₁ = 0, b₁ = 1, c₁ = 0} Second approximator ➔ max function |
| ReLU6 | ReLU6(x) = min(max(0,x) , 6) | Asymmetric = 0 Gain: (a_{G} = 0, b_{G} = 1) Constant = 0 First Approximator ➔ max function Second Approximator ➔ min function |
| Swish | swish(x) = x · sigmoid(x) | Asymmetric = 0 Gain: (a_{G} = 1, b_{G} = 0) Constant = 0 First Approximator ➔ quadratic parameters { a₁ = 0,b₁ = 1, c₁ = 0} Second Approximator ➔ sigmoid look-up table |
| Hard Swish | $\text{hswish} \left(x\right) = x \frac{R e L U 6 \left(x + 3\right)}{6}$ | Asymmetric = 0 Gain: $\left({a}_{G} = \frac{1}{6} , {b}_{G} = 0\right)$ Constant = 3 First Approximator➔ max function Second Approximator ➔ min function |
| Hyperbolic Tangent | $tanh \left(x\right) = \frac{{e}^{x} = {e}^{- x}}{{e}^{x} + {e}^{- x}}$ | Asymmetric = 0 Gain: (a_{G} = 0, b_{G} = 1) Constant = 0 First Approximator ➔ Quadratic parameters { a₁ = 0,b₁ = 1, c₁ = 0} Second Approximator ➔ tanh look-up table |
| Sigmoid | $σ \left(x\right) = \frac{{e}^{x}}{1 + {e}^{x}}$ | Asymmetric = 0 Gain: (a_{G} = 0, b_{G} = 1) Constant = 0 First Approximator ➔-linear parameters { a₁ = 1,b₁ = 0} Second approximator ➔ sigmoid look-up table |
| Exponential Linear Unit (ELU) | $\text{ELU} \left(x\right) = \left\{\begin{matrix}x & x > 0 \\ α \left({e}^{x} - 1\right) & x \leq 0\end{matrix}\right)$ | Asymmetric = 1 Gain: (a_{G} = 0, b_{G} = a) Constant = 0 For x ≥ 0: { First Approximator ➔ quadratic parameters { a₁ = 0,b₁ = ⅟α,c₁ = 0} Second approximator ➔ Bypass } For x < 0: { First Approximator ➔ Bypass Second approximator ➔ exponential look-up table } |
| Gated Error Linear Unit (GELU) | $\begin{matrix}\text{GELU} \left(x\right) \approx \\ 1 + tanh \left[\sqrt{\frac{2}{π}} \left(x + 0.044715 {x}^{3}\right)\right]\end{matrix}$ | Asymmetric = 0 Gain: (a_{G} = 0, b_{G} = 1) Constant = 1 First Approximator ➔ cubic parameters { Second Approximator ➔ tanh look-up table |
| GELU variant | GELU(x) ≈ x ∗ σ(1.702x) | Asymmetric = 0 Gain: (a_{G} = 1, b_{G} = 0) Constant = 0 First Approximator ➔ quadratic parameters { a₁ = 0,b₁ = 1.072, c₁ = 0} Second approximator ➔ sigmoid look-up table |

Note that in the ELU function above, the a parameter may be configured as a hyperparameter by a model designer.

Notably, in some implementations, parameters for an approximator may be given in a form (e.g., cubic with a, b, c, and d parameters or quadratic with a, b, and c parameters), even where the approximator is performing a lower order function (e.g., linear). This is because setting, for example, the cubic parameter a to zero effectively collapses the approximation equation to a lower order quadratic function, and likewise setting the quadratic parameter a to zero effectively collapses the approximation equation to a linear equation. Thus, an approximator may be configured, for example, for a “quadratic function” when it is configured with quadratic parameters, but the result of the parameters may reduce the function to a linear function, as in the example of ReLU above in Table 2. This may allow standardization of the parameter set despite the order of the underlying function to be configured by the parameters, thereby simplifying the implementation.

FIG. 2 depicts example circuit blocks 202 and 204 for implementing bypassable approximator blocks 206A and 206B. Bypassable approximator blocks 206A and 206B may correspond to first approximator block 102 and second approximator block 104 of FIG. 1 in one example.

In FIG. 2, circuit block 202 is configured to control use of function block 214A, which includes first approximator 206A and minimum and maximum function block 208A in this example. Similarly, circuit block 204 controls use of function block 214B, which includes minimum and maximum function block 208B and second approximator 206B, in this example. The first and second approximator blocks 206A and 206B may be configured to implement nonlinear activation functions, such as those described above with respect to Table 1.

Note that the first approximator 102 in FIG. 1 requires only one input, but circuit block 202 includes two input ports, 201A and 201B, which allows for multiple inputs. The depicted configuration of circuit block 202 may be adopted in order to present the same external interface for both circuit blocks 202 and 204, which may simplify configuration and integration. In some aspects, the two input ports 201A and 201B of circuit block 202 may be tied together in an implementation where circuit block 202 receives a single input (such as input data 101 in FIG. 1) via input port 201A. In an alternative implementation, circuit block 202 can be simplified by removing input port 201B and removing input mux 203A such that 201A would be provided directly to 214A and 207A.

Generally, input ports 201A and 201B may receive various types of input data for processing, including signed multibit integer data. In one example, the input data is 8-bit 2 s complement input data.

Input selector muxes 203A and 203B are configured to control which input data port is used for circuit blocks 202 and 204, respectively. For example, input selector mux 203B may select between input data port 201A (e.g., when circuit block 202 is being bypassed) or 212B (e.g., when circuit blocks 202 and 204 are being processed in series).

Bypass selector muxes 211A and 211B are configured to control bypassing function blocks 214A and 214B of circuit blocks 202 and 204, respectively. For example, when circuit block 202 is to be bypassed, bypass selector mux 211A selects bypass 205A to provide an output to output port 212A. Similarly, when circuit block 204 is to be bypassed, bypass selector mux 211B selects bypass 205B to provide an output to output port 216. Thus, processing with circuit block 202 and/or 204, as controlled by the configurable bypasses 205A and 205B, results in an output at output port 216.

As discussed in more detail with respect to FIG. 3, approximator blocks 206A and 206B may be configured with configuration parameters (e.g., function specific coefficients as in Table 1, above) stored in registers 219A and 219B, respectively. Similarly, as in Table 1, above, where approximator blocks 206A or 206B are configured to perform a look-up table-based function, the table values may be stored in registers 219A and 219B, respectively.

Each circuit block (202 and 204) further includes a minimum and maximum function block (208A for circuit block 202 and 208B for circuit block 204) for providing minimum and maximum functions. Generally, a minimum (or “min”) function will return the minimum value of the provided inputs. Similarly, a maximum (or “max”) function will return the maximum value of the provided inputs. In one example, minimum and maximum function blocks 208A and 208B may comprise multibit digital comparators that run in either a single cycle or multi-cycle mode.

The configuration of function blocks 214A and 214B may include a setting for function selector muxes 209A and 209B, respectively. In other words, whether or not function blocks 214A and 214B output a min/max output from mix/max blocks 208A and 208B or a value from approximators 206A and 206B is based on the configuration of function selector muxes 209A and 209B. Note that in other examples, function blocks 214A and 214B may include additional function blocks that may be selected by a mux.

As depicted in FIG. 1 where approximator blocks can be processed in series, in FIG. 2 the output 212A of circuit block 202A, which includes a first approximator block 206A, is provided as an input 212B to circuit block 204, which includes a second approximator block 206B. As in FIG. 1 where bypasses 105 and 107 control use of the first and second approximator blocks 102 and 104, here the selectable bypasses 205A and 205B control use of approximator blocks 206A and 206B.

An asymmetric signal line 210 controls a configuration of the circuit blocks 202 and 204. In one example, circuit blocks 202 and 204 are configured based on values on asymmetric signal line 210 and output values from sign blocks 207A and 207B based on the input data received via input data port 201A. For example, the binary value received via the asymmetric signal line 210 and the binary value output from sign block 207A interact at AND gate 213 to control the selection of output by mux 211A. As another example, the binary value received via the asymmetric signal line 210 and the binary value output from sign block 207B interact at AND gate 217 to control the selection of an input data port (as between 201A and 212B) via mux 203B. As a further example, the binary value received via the asymmetric signal line 210 and the inverted binary value output from sign block 207B interact at and gate 215 to control the selection of output mux 211B.

Table 2, below, provides a summary of configurations for circuit blocks 202 and 204:

TABLE 2

| Sign of Input Data at 201A | Asymm Value (210) | Bypass First Approximator (202) | Bypass Second Approximator (204) | First Approximator (206A) Output | Second Approximator (206B) Output |
|---|---|---|---|---|---|
| Positive Sign block (207A or 207B) output = 0 | 1 | No | Yes | Nonlinear based on configured nonlinear activation function if input value x ≥ 0 | Bypassed per 205B |
| Negative Sign block (207A or 207B) output = 1 | 1 or 0 | Yes | No | Bypassed per bypass 205A | Nonlinear based on configured nonlinear activation function if input value x < 0 |
| Positive or Negative | 0 | No | No | Nonlinear based on configured nonlinear activation function | Nonlinear based on configured nonlinear activation function |

### Example Approximator for Configurable Nonlinear Activation Function Circuit

FIG. 3 depicts an example approximator 300, which may be an example of one or both of first approximator 102 and second approximator 104 of FIG. 1 and/or approximators 206A and 206B of FIG. 2.

Approximator 300 receives input data 302 (e.g., pre-activation data) for processing. In some examples, input data 302 may be received from a buffer or other memory. In other examples, input data may be received directly from the output of another processing block, such as the output of a CIM array or another vector and matrix multiplication and accumulation block. Further, input data may be received from another approximator, such as if approximator 300 is the second approximator 104 in FIG. 1 and/or the second approximator 206B in FIG. 2.

In some implementations, an approximator (such as 300) may include alternative processing paths. In such cases, path logic 304 may be configured to route input data 302 to the appropriate processing path based on, for example, a configuration parameter for approximator 300.

In this example, processing path 306A provides a cubic approximation path for input data 302.

In processing path 306A, input data 302 is provided to cubic calculator 308, which performs a cubic operation (e.g., x³, where x is the input data) and then the output is multiplied with cubic parameter 312 at multiplier 310. The output of multiplier 310 is then provided to accumulator 324.

Input data 302 is also provided to quadratic calculator 314, which performs a quadratic operation (e.g., x², where x is the input data) and then the output is multiplied by quadratic parameter 318 at multiplier 316. The output of multiplier 316 is then provided to accumulator 324.

Input data 302 is also provided to multiplier 320 where it is multiplied by linear parameter 322. The output of multiplier 320 is then provided to accumulator 324.

Accumulator (adder) 324 accumulates the outputs of multipliers 310, 316, and 320 as well as intercept parameter 326 to generate output data 332.

Cubic parameter 312, quadratic parameter 318, linear parameter 322 and intercept parameter 326 may all be stored in a memory or the like (e.g., in registers) accessible to approximator 300. In some cases, a control unit, such as a memory control unit or finite state machine, may configure approximator 300 with parameters stored in the memory. In various examples, cubic parameter 312, quadratic parameter 318, linear parameter 322 and intercept parameter 326 may be set according to values described above with respect to Table 2.

As above, the order of the approximation can be configured by configuring the aforementioned parameter values. For example, for approximator 300 to perform a quadratic approximation, cubic parameter 312 can be set to zero. Similarly, for approximator 300 to perform a linear approximation, cubic parameter 312 and quadratic parameter 318 can be set to zero.

Certain nonlinear activation functions require alternative functions, such as minimum and maximum functions. Accordingly, processing path 306B provides a minimum and/or maximum calculator that may be used, for example, with the ReLU and ReLU6 functions described above in Table 2. Processing path 306B may be selected by path logic 304 based on configuration data for approximator 300.

Further, certain nonlinear activation functions may be implemented using look-up tables, which provide a more power and time efficient mechanism for generating values for certain nonlinear activation functions. Accordingly, processing path 306C provides a look-up table-based processing path that may be used, for example, wherever a sigmoid, tanh, or similar function is used by a nonlinear activation function. Note that sigmoid and tanh may be calculated from each other, so in some cases, only a single look-up table (e.g., sigmoid or tanh, but not both) is stored and used to implement both functions. One or more look-up tables may be stored in a memory and accessible to approximator 300, including a memory tightly coupled to approximator 300.

### Example Machine Learning Model Process Flow With Configurable Nonlinear Activation Function Circuit

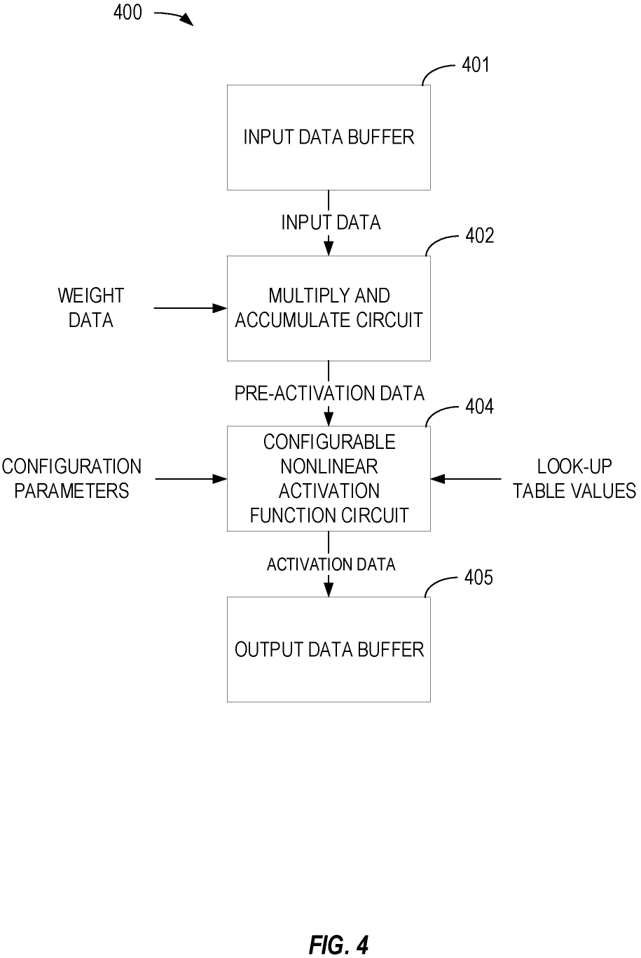

FIG. 4 depicts an example machine learning model data flow 400 that implements a configurable nonlinear activation function circuit, such as described above with respect to FIGS. 1-3.

In flow 400, input data is stored in an input data buffer 401 (e.g., machine learning model layer input data) and then provided to a multiply and accumulate (MAC) circuit 402. MAC circuit 402 may generally be configured to perform vector, array, and matrix multiplication and accumulation operations, such as those used frequently in convolutional neural networks. In some examples, MAC circuit 402 may include one or more compute-in-memory (CIM) arrays. Alternatively, or additionally, MAC circuit 402 may include a digital multiply and accumulate (DMAC). In yet further examples, multiply and accumulate circuit 402 may be a portion of a machine learning accelerator, such as a neural processing unit (NPU), or another type of processing unit optimized for performing machine learning processing. In another implementation, MAC circuit 402 may be replaced by a vector/matrix or matrix/matrix processing engine.

MAC circuit 402 processes the input data with weight data (e.g., neural network weight data) to generate pre-activation data. For example, MAC circuit 402 may process input data to a layer of a neural network model and generate pre-activation data as an output.

The pre-activation data is provided to configurable nonlinear activation (CNLA) function circuit 404, which is configured to generate output data (e.g., activations) based on a configured nonlinear activation function. The output data may then be stored in output data buffer 405 for subsequent use, such as for processing another layer in a machine learning model, or as output from the machine learning model, and the like.

CNLA function circuit 404 may be configured with configuration parameters, such as described with respect to CNLA function circuit 100 in FIG. 1 and/or approximator 300 in FIG. 3 and those described in Tables 1 and 2. Further, CNLA function circuit 404 may be configured to access look-up tables depending on the configured activation function.

In some cases, configuration parameters may include identification of a nonlinear activation function to be applied to the input data. Based on the determined nonlinear activation function, appropriate parameters (such as those in Table 2) may be retrieved from a memory (e.g., registers) and applied to CNLA function circuit 404 thereby configuring it for processing the input data. In some examples, a finite state machine, a memory control unit, or another controller, may perform the configuration of CNLA function circuit 404.

Notably, CNLA circuit 404 may be configured to process multiple batches of input data using the same configuration, or may update its configuration for every new batch of input data. Thus, CNLA circuit 404 provides a very flexible and efficient means for performing configurable nonlinear activations for machine learning tasks, such as training and inferencing.

### Example Method for Performing Processing Using a Configurable Nonlinear Activation Function Circuit

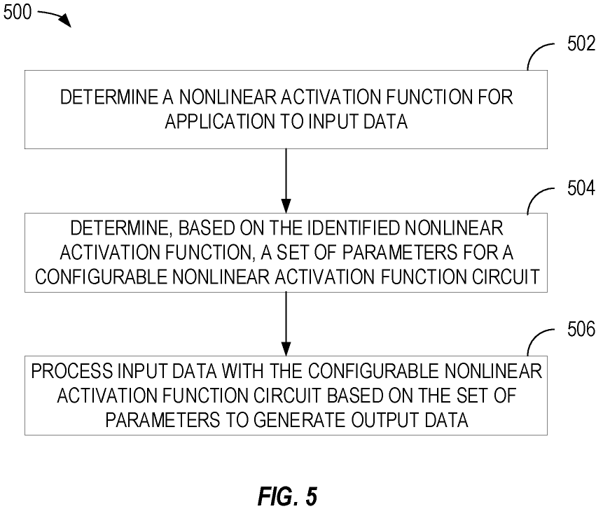

FIG. 5 depicts an example method 500 for performing processing using a configurable nonlinear activation function circuit.

Method 500 begins at step 502 with determining a nonlinear activation function for application to input data. For example, the nonlinear activation function may be one of the functions listed in Table 2, or another nonlinear activation function.

Method 500 then proceeds to step 504 with determining, based on the determined nonlinear activation function, a set of parameters for a configurable nonlinear activation function circuit. For example, the parameters for the determined nonlinear activation function may be as above in Tables 1 and 2.

Method 500 then proceeds to step 506 with processing input data with the configurable nonlinear activation function circuit based on the set of parameters to generate output data. For example, the output data may be activation data for a layer of a neural network model.

In some examples, the set of parameters includes a combination of one or more gain parameters, a constant parameter, and one or more approximation functions to apply to the input data via the configurable nonlinear activation function circuit. For example, the set of parameters may be as discussed above with respect to FIGS. 1 and 2 and in Table 1.

In some examples, method 500 further includes retrieving the set of parameters from a memory based on the determined nonlinear activation function. In some examples, the memory may be one or more registers storing the parameter values.

In some examples, the configurable nonlinear activation function circuit includes a first approximator configured to approximate a first function of the one or more approximation functions; a second approximator configured to approximate a second function of the one or more approximation functions; a first gain multiplier configured to multiply a first gain value based on one or more gain parameters; and a constant adder configured to add a constant value, such as depicted and described with respect to FIG. 1.

In some examples, the configurable nonlinear activation function circuit includes a first bypass configured to bypass the first approximator. In some examples, the configurable nonlinear activation function circuit includes a second bypass configured to bypass the second approximator. In some examples, the configurable nonlinear activation function circuit includes an input data bypass configured to bypass the first approximator and to provide input data to the second approximator.

In some examples, at least one of the first approximator and the second approximator is a cubic approximator. In some examples, an other one of the first approximator and the second approximator is one of a quadratic approximator or a linear approximator. In some examples, an other one of the first approximator and the second approximator is configured to perform a min or max function, such as depicted with respect to path 306B in FIG. 3. In some examples, an other one of the first approximator and the second approximator is configured to access a look-up table for an approximated value, such as depicted with respect to path 306C in FIG. 3.

In some examples, both the first approximator and the second approximator are cubic approximators.

Note that FIG. 5 is just one example, and in other examples, methods such as those described herein, may be implemented with more, fewer, and/or different steps.

### Example CNLA Architecture for Softmax Operations Using Parallel Input Data

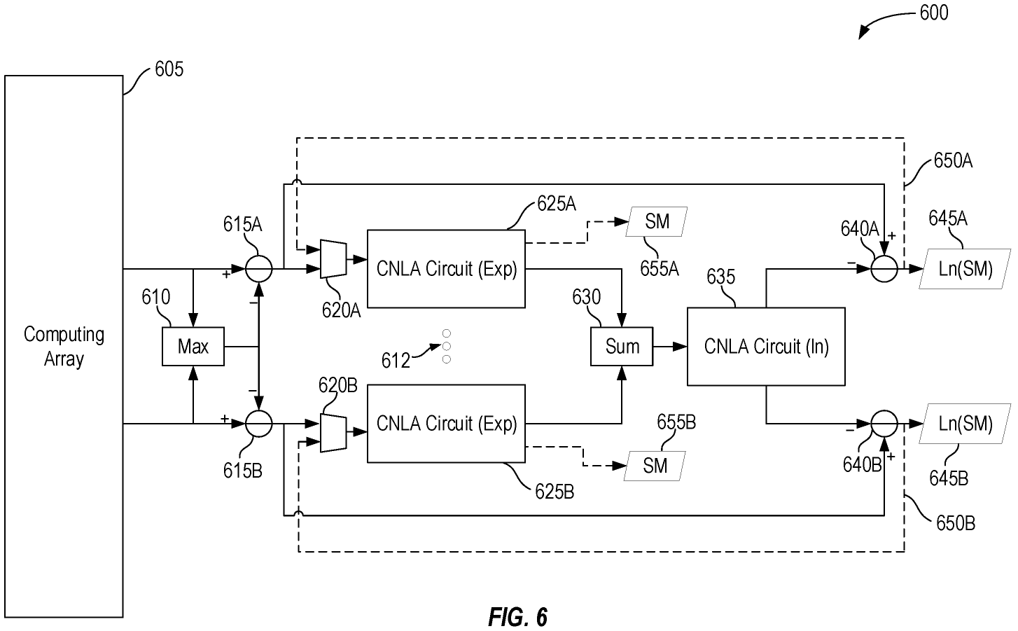

FIG. 6 depicts an example architecture 600 using CNLA function circuits to perform softmax operations using parallel input data.

Softmax (SM) functions are used in a wide variety of machine learning models, such as in many neural network (NN) architectures. For example, SM functions are often used in the last layer (after the fully connected (FC)/dense layer) of a neural network to provide multi-category classification (such as digit recognition). SM is also used in attention-based calculations (e.g., in transformer models). Generally, SM maps the output of neurons (e.g., a set of values in a tensor or vector) to an interval (e.g., to values between zero and one), ensuring that the sum of the mapped values is one.

As discussed above and in more detail below, exponential, logarithm, and natural logarithm (In) functions can be calculated with the above-described CNLA architectures, such as by using hardware look-up tables. As discussed below in more detail, therefore, CNLA circuits can be configured to provide SM functionality (also referred to as approximated SM functionality). In some aspects, the CNLA circuits are configured to provide exact SM functionality if they are configured to perform exponent and logarithm operations, as well approximated SM functionality if they are configured to perform approximated exponent and logarithm operations (e.g., using lookup tables).

In at least one aspect, the SM function may be defined as

$$S M \left(x\right) = \frac{{e}^{{x}_{j}}}{{\sum }_{j = 0}^{N - 1} {e}^{{x}_{j}}} ,$$

where x is the input data (e.g., a tensor or vector containing values output by neurons in a network), and xⱼ is the j-th element of the vector x. In some aspects, the SM function may alternatively be defined as

$$S M \left(x\right) = \frac{{e}^{{x}_{j}} {}^{- {x}_{m a x}}}{{\sum }_{j = 0}^{N - 1} {e}^{{x}_{j}} {}^{- {x}_{m a x}}} ,$$

where xₘₐₓ = max(xⱼ,j = 0: N - 1) (e.g., where xₘₐₓ is the maximum value in the vector x). In one aspect, using this latter definition can be used to reduce the dynamic range of the data.

Additionally, in some aspects, a log softmax (Log(SM)) may be used in various architectures. In one aspect, the log softmax function can be defined as

$$log ( S M ( x ) ) = {x}_{j} - log ( {Σ}_{j = 0}^{N - 1} {e}^{{x}_{j}} )$$

$$( \text{or} log ( S M ( x ) ) = {x}_{j} - log ( {Σ}_{j = 0}^{N - 1} {e}^{{x}_{j} - {x}_{m a x}} ) ) ,$$

where log() is a natural logarithm. In some aspects, the computationally expensive division of the SM function can be avoided by transforming the domain to the log domain (e.g., by using the log softmax).

As discussed in more detail below, using the illustrated architecture 600, an approximated log softmax value 645 can be generated using a combination of CNLA blocks. In some aspects, if the original (linear) softmax domain is desired, then the log softmax can be processed using another CNLA (e.g., CNLA circuit 635), as discussed in more detail below. This may generally be referred to herein as a “two-phase softmax operation.”

Additionally, in some aspects, if the softmax function is being used for multi-category classification, then a simplified calculation may be sufficiently close to the actual value by simply ignoring the denominator of the SM functions defined above (e.g., where

$$S M ( x ) \approx {e}^{{x}_{j}} {}^{- {x}_{m a x}} ) .$$

In some aspects, this may be referred to herein as a “single-phase softmax operation.” In one aspect, if the single-phase softmax operation is desired, then the CNLA circuit 635 may be bypassed.

In the illustrated architecture 600, a computing array 605 provides input data (e.g., a tensor or vector) to be processed using a softmax operation (e.g., using an approximated softmax and/or an approximated log softmax operation). In the illustrated example, the computing array 605 is configured to output a set of data (e.g., multiple elements in the vector) in parallel. For example, the computing array 605 may be a CIM array. The computing array 605 can generally be used to perform any process or operation, such as to generate the output of a layer of a neural network (e.g., by multiplying input data with a set of weights associated with the layer).

In the illustrated example, two different processing paths are shown (e.g., a first path including elements 615A, 620A, 625A, 640A, 645A, 650A, and 655A, and a second path including elements 615B, 620B, 625B, 640B, 645B, 650B, and 655B). In the illustrated example, the architecture 600 further includes several common or shared elements across the processing paths, including max block 610, sum block 630, and CNLA circuit 635, described in more detail below.

Although two paths are depicted for conceptual clarity, there may be any number of processing paths in the architecture 600 (as indicated by ellipses 612). In at least one aspect, each path is associated with a corresponding output element of the computing array 605 (e.g., a corresponding value in the vector or tensor). That is, each element xⱼ in vector x may have a corresponding path (including a corresponding CNLA circuit 625). For example, if there are sixty-four elements in the vector, then the architecture 600 may include sixty-four CNLA circuits 625. In at least one aspect, each processing path corresponds to a channel of output generated by the computing array 605.

As illustrated, each output element (e.g., each value in the vector x) of the computing array 605 is provided to a max block 610. The max block 610, which may be implemented using hardware or software, generally corresponds to a computing component that identifies and outputs the maximum value of its input data. In the illustrated aspect, therefore, the max block 610 identifies xₘₐₓ from x (regardless of the number of values in x or the number of processing paths included in the architecture 600), and provides xₘₐₓ to operations 615A and 615B. In an aspect, the max block 610 can identify the maximum value by evaluating all input values in parallel. Additionally, each operation 615A and 615B receives a corresponding element from the computing array 605. That is, the operation 615A may receive a first value xₐ, while the operation 615B may receive a second value x_{b}.

In the illustrated example, the operations 615A and 615B (collectively “operations 615”) are a subtraction operation, where xₘₐₓ is subtracted from xⱼ . Specifically, operation 615A computes xₐ - xₘₐₓ, while operation 615B computes x_{b} - xₘₐₓ. As illustrated, these values are then provided to corresponding multiplexers 620A and 620B (collectively “multiplexers 620”).

In some aspects, the multiplexers 620 are used to enable performing two-phase softmax operations (e.g., when the desired output is the linear SM), as discussed above and described in more detail below. In an aspect, if an approximated log softmax is desired and/or if single-phase softmax operations are being used (or during the first phase of a two-phase operation), then the multiplexers 620 may be used to provide the output of operation 615 directly to the CNLA circuit 625. In the illustrated example, the outputs of the multiplexers 615A and 615B are also provided to operations 640A and 640B, respectively, discussed in more detail below.

As illustrated, the outputs of the multiplexers 620 (or the outputs of the operations 615, as discussed above) are then provided to respective CNLA circuits 625. Specifically, the outputs of multiplexer 620A (e.g., computed based on xₐ) are provided to a first CNLA circuit 625A, while outputs of multiplexer 620B (e.g., computed based on x_{b}) are provided to a second CNLA circuit 625B.

In at least one aspect, the CNLA circuits 625A and 625B (collectively, “CNLA circuits 625”) may correspond to CNLA function circuit 100 of FIG. 1. In the specific illustrated architecture 600, the CNLA circuits 625 are configured to perform exponential operations or functions. That is, the CNLA circuits 625 are configured to compute (or approximate) an exponent output based on input (e.g., to compute or approximate eⁿ, where n is the input data provided to the CNLA circuit 625).

In one aspect, to perform this exponent operation, the CNLA circuits 625 may use gain parameters comprising a dependent parameter value of 0 and an independent parameter value of 1, as well as a constant value of 0, where the first function is bypassed and the second function is an exponential look-up table. In some aspects, the first function may be an exponential look-up table while the second function is bypassed. In this way, the CNLA circuits 625 can provide an exponential function.

As illustrated, the output of each CNLA circuit 625 is therefore equal to or approximates

$${e}^{x} {}^{{}_{j} - {x}_{m a x}} .$$

Specifically, the CNLA circuit 625A outputs

$${e}^{{x}_{a} - {x}_{m a x}} ,$$

while CNLA circuit 625B outputs

$${e}^{{x}_{b} - {x}_{m a x}} .$$

In the illustrated example, the CNLA circuit 625 outputs from each processing path (regardless of the number of processing paths) are then provided to a sum block 630. That is, the sum block 630 may receive input from each of the processing paths, regardless of the number of such paths. The sum block 630, which may be implemented using hardware or software, generally corresponds to a computing component that sums the input values received and outputs the sum. In an aspect, the sum block 630 can sum all input values in parallel. In the illustrated aspect, therefore, the sum block 630 receives

$${e}^{{x}_{j} - {x}_{m a x}}$$

from each CNLA circuit 625, sums these values, and outputs the resulting sum to a CNLA circuit 635.

In at least one aspect, the CNLA circuit 635 may correspond to CNLA function circuit 100 of FIG. 1. In the specific illustrated architecture 600, the CNLA circuit 635 is configured to perform logarithmic operations or functions. That is, the CNLA circuit 635 is configured to compute (or approximate) a logarithmic (e.g., a natural log) output based on input (e.g., to compute or approximate Zn(n), where n is the input data provided to the CNLA circuit 635).

In one aspect, to perform this exponent operation, the CNLA circuit 635 may use gain parameters comprising a dependent parameter value of 0 and an independent parameter value of 1, as well as a constant value of 0, where the first function is bypassed and the second function is a logarithmic look-up table (e.g., a natural log look-up table). In some aspects, the first function may be a logarithmic look-up table while the second function is bypassed. In this way, the CNLA circuit 635 can provide a logarithmic function.

As illustrated, the output of the CNLA circuit 635 is therefore equal to or approximates

$$log \left({\sum }_{j = 0}^{N - 1} {e}^{{x}_{j} - {x}_{m a x}}\right) .$$

In the illustrated example, the output of the CNLA circuit 635 is then provided to operations 640A and 640B (collectively, “operations 640”). In the illustrated example, each operation 640 is associated with a corresponding processing path, as discussed above. Specifically, the operation 640A corresponds to the processing path used to process a first value xₐ, and the operation 640B corresponds to the processing path used to process a second value x_{b}. In the illustrated example, the operation 640A (or 640B) subtracts the output of the CNLA circuit 635 from the output of the corresponding operation 615A (or 615B).

That is, the operations 640 may compute

$${x}_{j} - log \left({\sum }_{j = 0}^{N - 1} {e}^{{x}_{j} - {x}_{m a x}}\right) .$$

In the illustrated example, therefore the operation 640A may compute

$${x}_{a} - log \left({\sum }_{j = 0}^{N - 1} {e}^{{x}_{j} - {x}_{m a x}}\right) ,$$

while operation 640B computes

$${x}_{b} - log \left({\sum }_{j = 0}^{N - 1} {e}^{{x}_{j} - {x}_{m a x}}\right) .$$

As discussed above and depicted in the illustrated example, the output of the operations 640 are therefore log softmax values 645A and 645B (collectively “log softmax values 645”). That is, the log softmax value 645A may equal or approximate log(SM(xₐ)), while the log softmax value 645B may equal or approximate log(SM(x_{b})). In some aspects, if the log softmax is the desired output, the log softmax values 645 may then be provided as output from the architecture 600 (e.g., as output from the model, or as input to a subsequent layer of the neural network).

In at least one aspect, as discussed above, in single-phase operations, the system may provide the output of the sum block 630 directly to the operations 640, rather than using the CNLA circuit 635. This can enable more efficient generation of approximated softmax values in some implementations.

As discussed above, if the desired output of the architecture is a linear softmax value and the architecture is using a two-phase operation, then the optional paths 650A and 650B (collectively, “paths 650”) may be used. In the illustrated example, these paths 650 provide the generated log softmax values 645 back to multiplexers 620 during a second or subsequent cycle or phase. That is, the depicted components may, in a first phase (e.g., during a first set of one or more clock cycles), process the output of the computing array 605 to generate the log softmax values 645. During a subsequent phase (e.g., during a second set of one or more clock cycles), the log softmax values 645 can be provided back to the multiplexers 620/the CNLA circuits 625.

In some aspects, during this second phase, the multiplexers 620 can pass the log softmax values 645 to the corresponding CNLA circuits 625. That is, the multiplexers 620 can each provide the generated log softmax values 645 directly to a corresponding CNLA circuit 625. Specifically, the log softmax value 645A is provided as input to the CNLA circuit 625A, and the log softmax value 645B is provided as input to the CNLA circuit 625B. Although the illustrated example depicts providing the log softmax values 645 back to the CNLA circuits 625, in some aspects, the architecture may use a second set of CNLA circuits, discrete from the CNLA circuits 625, to provide the further exponential operations.

As illustrated and discussed above, the CNLA circuits 625 are configured to compute exponent outputs based on the input data. Therefore, when receiving the log softmax values 645, each CNLA circuit 625 generates and outputs a corresponding linear softmax value 655 (e.g., linear softmax values 655A and 655B). That is, each CNLA circuit 625 can compute exp(log(SM(xⱼ))) for a corresponding j-th value from the input vector. In this way, the output of the CNLA circuits 625 equals or approximates the SM function discussed above.

In an aspect, these linear softmax values 655 may then be provided as output from the architecture 600 (e.g., as output from the model, or as input to a subsequent layer of the neural network).

### Example CNLA Architecture for Softmax Operations Using Sequential Input Data

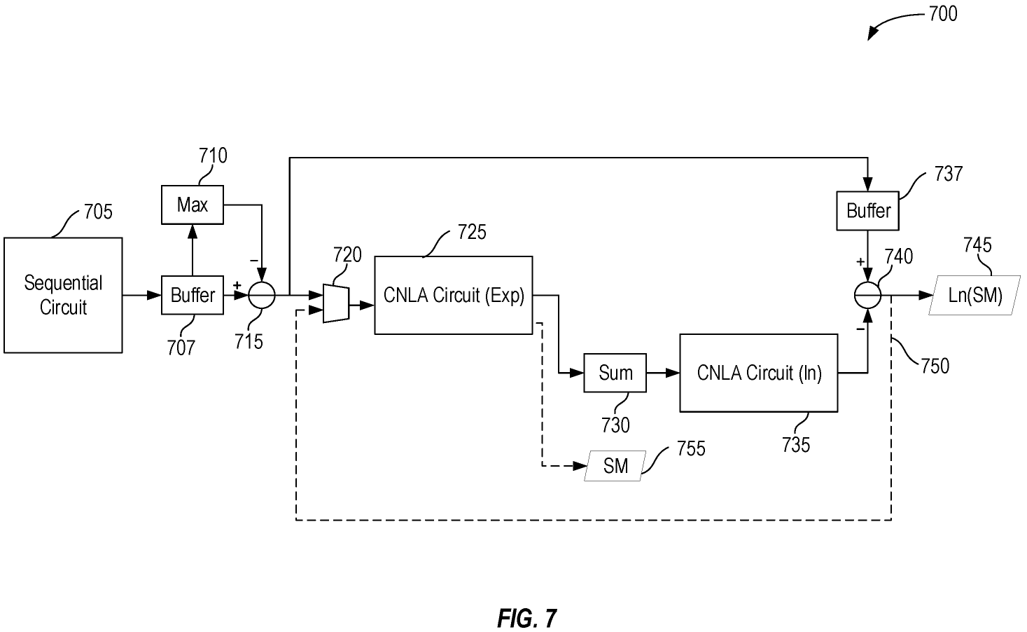

FIG. 7 depicts an example architecture 700 using CNLA function circuits to perform softmax operations using sequential input data.

As discussed in more detail below, using the illustrated architecture 700, an approximated log softmax value 745 can be generated using a combination of CNLA blocks. In some aspects, if the original (linear) softmax domain is desired, then the log softmax can be processed using another CNLA (e.g. CNLA circuit 735), as discussed above and in more detail below. This may generally be referred to herein as a “two-phase softmax operation.”

Additionally, as discussed above, if the softmax function is being used for multi-category classification, then a simplified calculation may be sufficiently close to the actual value by simply ignoring the denominator of the SM functions defined above (e.g., where

$$S M ( x ) \approx {e}^{{x}_{j} - {x}_{m a x}} ) .$$

As discussed above, this may be referred to herein as a “single-phase softmax operation.” In one aspect, if the single-phase softmax operation is desired, then CNLA circuit 735 may be bypassed.

In the illustrated architecture 700, a sequential circuit 705 provides input data (e.g., values or data elements of a tensor or vector) to be processed using a softmax operation (e.g., using an approximated softmax and/or an approximated log softmax operation). In the illustrated example, the sequential circuit 705 is configured to output data elements sequentially. That is, while the architecture 600 of FIG. 6 is configured for parallel data input, the illustrated architecture 700 is configured to process sequential input (e.g., where the data elements are output one at a time by the sequential circuit 705). For example, the sequential circuit 705 may be a DMAC circuit. The sequential circuit 705 can generally be used to perform any process or operation, such as to generate the output of a layer of a neural network (e.g., by sequentially multiplying input data elements with corresponding weights associated with the layer).

In the illustrated example, in contrast to the above architecture 600 of FIG. 6, a single processing path is used to process the output of the sequential circuit 705, and the architecture 700 processes the output sequentially. That is, each element xⱼ in vector x may be processed in sequence using the illustrated processing path. For example, each clock cycle, a new element xⱼ may be output by the sequential circuit 705 to begin processing using the illustrated architecture 700. In at least one aspect, the architecture 700 can be used to sequentially process data elements in a given channel of data that is output by a layer of a neural network, and a separate architecture 700 may be used to process each respective channel.

As illustrated, each output element is first provided to a buffer 707. In an aspect, the buffer 707 is a memory or storage component (e.g., a register file) that buffers or stores each output element from the sequential circuit 705. For example, as the sequential circuit 705 outputs each xⱼ until all of the vector x has been generated, the buffer 707 can store each element until the entire vector is stored. As illustrated, the buffer 707 outputs the elements to a max block 710. In some embodiments, though a buffer 707 is depicted, the output of the sequential circuit 705 may instead be provided directly to the max block 710. That is, the buffer 707 may be used to provide input to operation 715, and the max block 710 may also receive the buffer output or may receive input directly from the sequential circuit 705 (in sequence).

The max block 727, which may be implemented using hardware or software, generally corresponds to a computing component that identifies and outputs the maximum value of its input data. In the illustrated aspect, therefore, the max block 710 identifies xₘₐₓ from x. In some embodiments, using the buffer 707, the max block 710 can evaluate the entire vector x at once. In some aspects where the buffer 707 is not used, the max block 710 can sequentially evaluate each xⱼ as it is received. For example, the max block 707 may evaluate each newly received value xⱼ to determine whether this value is larger than the xₘₐₓ currently being stored by the max block 707. If so, then the new value can be buffered as the new/current xₘₐₓ. Once all of the data elements have been evaluated, the max block 707 can output the determined maximum value.

In the illustrated example, the max block 710 and buffer 707 then output data to the operation 715. That is, the max block 710 outputs the maximum value in x to the operation 715, which also receives the output of the buffer 707 (e.g., the entire vector x). In the illustrated example, the operation 715 is a subtraction operation, where xₘₐₓ (output by the max block 707) is subtracted from x (output by the buffer 707). Specifically, operation 715 computes x - xₘₐₓ for all values in x. As illustrated, these values are then provided to a multiplexer 720. In the illustrated example, the output of the operation 715 is also provided to a buffer 737.

In an aspect, in a similar manner to the buffer 707, the buffer 737 is a memory or storage component (e.g., a register file) that buffers or stores each output element from the operation 715. For example, as the operation 715 outputs each xⱼ - xₘₐₓ until all of the vector x has been generated/evaluated, the buffer 737 can store each element until the entire vector has been processed (e.g., until each value xⱼ - xₘₐₓ has been computed).

In the illustrated example, the multiplexer 720 is used to enable performing two-phase softmax operations (e.g., when the desired output is the linear SM), as discussed above and described in more detail below. In an aspect, if an approximated log softmax is desired and/or if single-phase softmax operations are being used (or during the first phase of a two-phase operation), then the multiplexer 720 may be used to provide the output of operation 715 directly to the CNLA circuit 725.

In at least one aspect, the CNLA circuit 725 may correspond to CNLA function circuit 100 of FIG. 1. In the specific illustrated architecture 700, the CNLA circuit 725 is configured to perform exponential operations or functions. That is, the CNLA circuit 725 is configured to compute (or approximate) an exponent output based on input (e.g., to compute or approximate eⁿ, where n is the input data provided to the CNLA circuit 725).

In one aspect, to perform this exponent operation, the CNLA circuit 725 may use gain parameters comprising a dependent parameter value of 0 and an independent parameter value of 1, as well as a constant value of 0, where the first function is bypassed and the second function is an exponential look-up table. In some aspects, the first function may be an exponent look-up table while the second function is bypassed. In this way, the CNLA circuit 725 can provide an exponential function.

As illustrated, the output of the CNLA circuit 725 is therefore equal to or approximates

$${e}^{{x}_{j} - {x}_{m a x}} .$$

In the illustrated example, the output of the CNLA circuit 725 is then provided to a sum block 730 and an operation 740.

The sum block 730, which may be implemented using hardware or software, generally corresponds to a computing component that sums the input values received and outputs the sum. In an aspect, the sum block 730 can similarly sum the received input values sequentially, as these values are received. That is, the sum block 730 can add each newly received

$${e}^{{x}_{j} - {x}_{m a x}}$$

value to the running sum. When all of the elements have been received, the sum block 730 can output the sum.

In the illustrated example, the generated sum is output, by the sum block 730, to a CNLA circuit 735. In at least one aspect, the CNLA circuit 735 may correspond to CNLA function circuit 100 of FIG. 1. In the specific illustrated architecture 700, the CNLA circuit 735 is configured to perform logarithmic operations or functions. That is, the CNLA circuit 735 is configured to compute (or approximate) a logarithm (e.g., a natural log) output based on input (e.g., to compute or approximate ln(n), where n is the input data provided to the CNLA circuit 735).

In one aspect, to perform this exponent operation, the CNLA circuit 735 may use gain parameters comprising a dependent parameter value of 0 and an independent parameter value of 1, as well as a constant value of 0, where the first function is bypassed and the second function is a logarithmic look-up table (e.g., a natural log look-up table). In some aspects, the first function may be a logarithmic look-up table while the second function is bypassed. In this way, the CNLA circuit 735 can provide a logarithmic function.

As illustrated, the output of the CNLA circuit 735 is therefore equal to or approximates

$$log \left({\sum }_{j = 0}^{N - 1} {e}^{{x}_{j} - {x}_{m a x}}\right)$$

. In the illustrated example, the output of the CNLA circuit 735 is then provided to operation 740. In the illustrated example, the operation 740 subtracts the output of the CNLA circuit 735 from the output of the buffer 737. That is, the operation 740 may compute

$$x - log \left({\sum }_{j = 0}^{N - 1} {e}^{{x}_{j} - {x}_{m a x}}\right) .$$

As discussed above and depicted in the illustrated example, the output of the operation 740 is therefore log softmax values 745 for all x values output by the sequential circuit 705. In some aspects, if the log softmax is the desired output, the log softmax values 745 may then be provided as output from the architecture 700 (e.g., as output from the model, or as input to a subsequent layer of the neural network).

In at least one aspect, as discussed above, in single-phase operations, the system may provide the output of the sum block 730 directly to the operation 740, bypassing the CNLA circuit 735. This can enable more efficient generation of approximated softmax values in some implementations.

As discussed above, if the desired output of the architecture is a linear softmax value and the architecture is using a two-phase operation, then the optional path 750 may be used. In the illustrated example, this path 750 provides the generated log softmax values 745 back to multiplexer 720 during a second or subsequent cycle or phase. That is, the depicted components may, in a first phase (e.g., during a first set of one or more clock cycles), process the output of the sequential circuit 705 to generate the log softmax values 745. During a subsequent phase (e.g., during a second set of one or more clock cycles), the log softmax values 745 can be provided back to the multiplexer 720/the CNLA circuit 725.

Although the illustrated example depicts providing the log softmax values 745 back to the CNLA circuit 725 (via the multiplexer 720), in some aspects, the architecture may use a second CNLA circuit, discrete from the CNLA circuit 725, to provide the further exponential operations.

As illustrated and discussed above, the CNLA circuit 725 is configured to compute exponent outputs based on the input data. Therefore, when receiving the log softmax values 745, the CNLA circuit 725 generates and outputs a corresponding set of linear softmax values 755. That is, the CNLA circuit 725 can compute exp(x - log(SM)) for all x values in the input vector. In this way, the output of the CNLA circuit 725 equals or approximates the SM function discussed above.

In an aspect, these linear softmax values 755 may then be provided as output from the architecture 700 (e.g., as output from the model, or as input to a subsequent layer of the neural network).

### Example Method for Performing Approximated Softmax Operations Using a CNLA Function Circuit

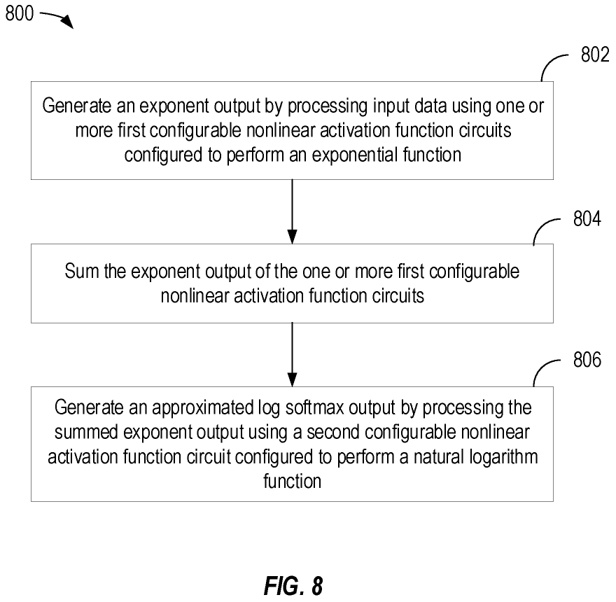

FIG. 8 depicts an example method 800 for performing approximated softmax operations using a configurable nonlinear activation function circuit.

At block 802, an exponent output is generated by processing input data using one or more first configurable nonlinear activation function circuits (e.g., first approximator 102 of FIG. 1, approximator block 206A of FIG. 2, approximator 300 of FIG. 3, CNLA circuits 625 of FIG. 6, and/or CNLA circuit 725 of FIG. 7) configured to perform an exponential function.

At block 804, the exponent output of the one or more first configurable nonlinear activation function circuits is summed (e.g., using sum block 630 of FIG. 6 and/or sum block 730 of FIG. 7).

At block 806, an approximated log softmax output is generated by processing the summed exponent output using a second configurable nonlinear activation function circuit (e.g., second approximator 104 of FIG. 1, approximator block 206B of FIG. 2, approximator 300 of FIG. 3, CNLA circuit 635 of FIG. 6, and/or CNLA circuit 735 of FIG. 7) configured to perform a natural logarithm function.

In some aspects, the method 800 further includes generating an approximated softmax of the input data by processing the approximated log softmax of the input data using the one or more first configurable nonlinear activation function circuits.

In some aspects, the one or more first configurable nonlinear activation function circuits comprise a plurality of first configurable nonlinear activation circuits, each associated with a corresponding output element from a parallelized computing array.

In some aspects, the method 800 further includes determining a maximum value from the output elements of the parallelized computing array and providing the maximum value from the output elements to the one or more first configurable nonlinear activation function circuits.

In some aspects, the one or more first configurable nonlinear activation function circuits comprise a single first configurable nonlinear activation circuit that receives input data from a sequential computing circuit.

In some aspects, the method 800 further includes determining a maximum output from the single first configurable nonlinear activation circuit.

In some aspects, the method 800 further includes buffering output from the sequential computing circuit.

In some aspects, the method 800 further includes determining a nonlinear activation function for application to input data, determining, based on the determined nonlinear activation function, a set of parameters for a configurable nonlinear activation function circuit, and processing input data with the configurable nonlinear activation function circuit based on the set of parameters to generate output data.

In some aspects, the method 800 further includes retrieving the set of parameters from a memory based on the determined nonlinear activation function.

In some aspects, the set of parameters includes a combination of one or more gain parameters, a constant parameter, and one or more approximation functions to apply to the input data via the configurable nonlinear activation function circuit.

In some aspects, at least one of the first configurable nonlinear activation function circuits comprises: a first approximator configured to approximate a first function of the one or more approximation functions, a second approximator configured to approximate a second function of the one or more approximation functions, a first gain multiplier configured to multiply a first gain value based on the one or more gain parameters, and a constant adder configured to add a constant value based on the constant parameter.

In some aspects, the at least one of the first configurable nonlinear activation function circuits further comprises: a first bypass configured to bypass the first approximator, a second bypass configured to bypass the second approximator, and an input data bypass configured to bypass the first approximator and to provide the input data to the second approximator.

In some aspects, the determined nonlinear activation function comprises an exponential function, the gain parameters comprise a dependent parameter value of 0 and an independent parameter value of 1, the constant value is 0, the first function is bypassed, and the second function is an exponential look-up table.

### Example Processing System

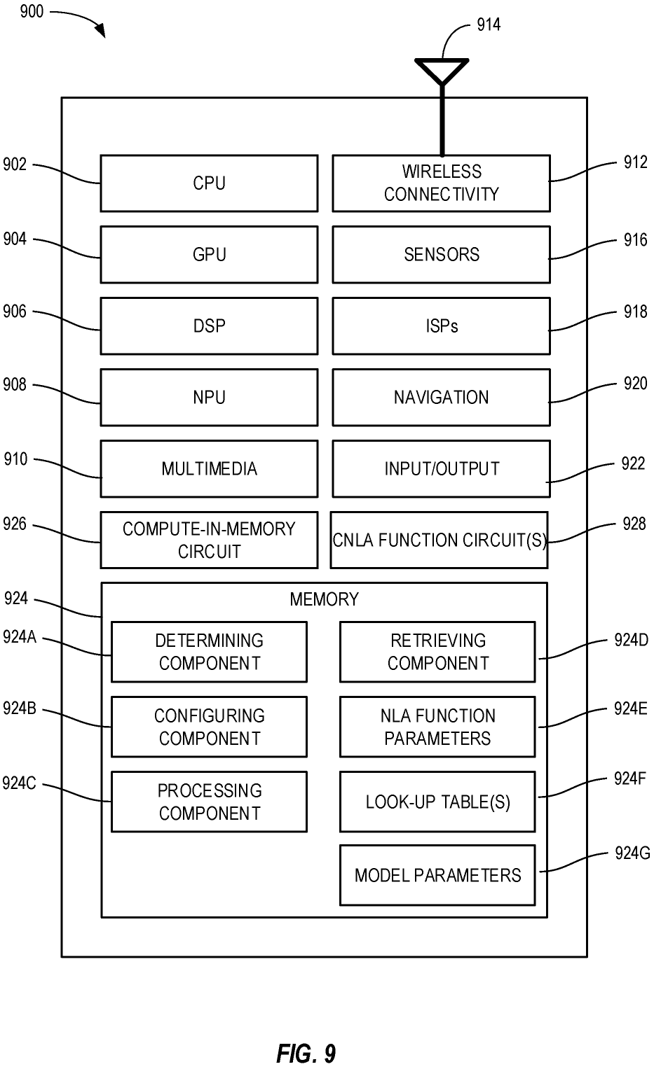

FIG. 9 depicts an example processing system 900 that may be configured to implement the systems, techniques, architectures, and methods described herein, such as with respect to FIGS. 1-8.

Processing system 900 includes a central processing unit (CPU) 902, which in some examples may be a multi-core CPU. Instructions executed at the CPU 902 may be loaded, for example, from a program memory associated with the CPU 902 or may be loaded from memory partition 924.

Processing system 900 also includes additional processing components tailored to specific functions, such as a graphics processing unit (GPU) 904, a digital signal processor (DSP) 906, a neural processing unit (NPU) 908, a multimedia processing unit 910, and a wireless connectivity component 912.

An NPU, such as 908, is generally a specialized circuit configured for implementing all the necessary control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

NPUs, such as 908, may be configured to accelerate the performance of common machine learning tasks, such as image classification, machine translation, object detection, and various other tasks. In some examples, a plurality of NPUs may be instantiated on a single chip, such as a system on a chip (SoC), while in other examples they may be part of a dedicated machine learning accelerator device.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In some aspects, NPU 908 may be implemented as a part of one or more of CPU 902, GPU 904, and/or DSP 906.

In some aspects, wireless connectivity component 912 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity processing component 912 is further connected to one or more antennas 914.

Processing system 900 may also include one or more sensor processing units 916 associated with any manner of sensor, one or more image signal processors (ISPs) 918 associated with any manner of image sensor, and/or a navigation processor 920, which may include satellite-based positioning system components (e.g., GPS or GLONASS) as well as inertial positioning system components.

Processing system 900 may also include one or more input and/or output devices 922, such as screens, touch-sensitive surfaces (including touch-sensitive displays), physical buttons, speakers, microphones, and the like.

In some examples, one or more of the processors of processing system 900 may be based on an ARM or RISC-V instruction set.

Processing system 900 also includes various circuits in accordance with the various aspects described herein.

In this example, processing system 900 includes compute-in-memory (CIM) circuit 926, which may be configured to perform efficient multiply-and-accumulate (MAC) functions for processing machine learning model data. Processing system 900 further includes configurable nonlinear activation (CNLA) function circuit 928. In some cases, CNLA function circuit 928 may be like CNLA function circuit 200 described with respect to FIG. 2. CNLA function circuit 928, as well as others not depicted, may be configured to perform various aspects of the methods described herein, such as flow 400 with respect to FIG. 4.

In some examples, CNLA function circuit 928 may be implemented as a part of another processing unit, such as CPU 902, GPU 904, DSP 906, or NPU 908.

Processing system 900 also includes memory 924, which is representative of one or more static and/or dynamic memories, such as a dynamic random access memory, a flash-based static memory, and the like. In this example, memory 924 includes computer-executable components, which may be executed by one or more of the aforementioned components of processing system 900.

In particular, in this example, memory 924 includes determining component 924A, configuring component 924B, processing component 924C, retrieving component 924D, nonlinear activation function parameters 924E, look-up table(s) 924F, and model parameters 924G (e.g., weights, biases, and other machine learning model parameters). One or more of the depicted components, as well as others not depicted, may be configured to perform various aspects of the methods described herein.

Generally, processing system 900 and/or components thereof may be configured to perform the methods described herein.

Notably, in other aspects, aspects of processing system 900 may be omitted, such as where processing system 900 is a server computer or the like. For example, multimedia component 910, wireless connectivity 912, sensors 916, ISPs 918, and/or navigation component 920 may be omitted in other aspects. Further, aspects of processing system 900 maybe distributed.

Note that FIG. 9 is just one example, and in other examples, alternative processing system with more, fewer, and/or different components may be used.

### Example Clauses

Implementation examples are described in the following numbered clauses:

Clause 1: A processor, comprising: one or more first configurable nonlinear activation function circuits configured to perform an exponential function on input data; a summation circuit configured to receive output data of the one or more first configurable nonlinear activation function circuits; and a second configurable nonlinear activation function circuit configured to receive output data of the summation circuit, perform a natural logarithm function, and output an approximated log softmax of the input data.

Clause 2: The processor of Clause 1, wherein the second configurable nonlinear activation function circuit is configured to output the approximated log softmax of the input data during a first cycle, wherein during a second cycle subsequent to the first cycle, the approximated log softmax of the input data is provided as input to the one or more first configurable nonlinear activation function circuits, and wherein the one or more first configurable nonlinear activation function circuits are configured to output an approximated softmax of the input data based on the approximated log softmax of the input data.

Clause 3: The processor of any of Clauses 1-2, wherein the one or more first configurable nonlinear activation function circuits comprise a plurality of first configurable nonlinear activation circuits, each associated with a corresponding output element from a parallelized computing array.

Clause 4: The processor of any of Clauses 1-3, further comprising a max circuit configured to: receive output elements from the parallelized computing array as input, and output a maximum value from the output elements to the one or more first configurable nonlinear activation function circuits.

Clause 5: The processor of any of Clauses 1-4, wherein the one or more first configurable nonlinear activation function circuits comprise a single first configurable nonlinear activation circuit configured to receive the input data from a sequential computing circuit.

Clause 6: The processor of any of Clauses 1-5, further comprising a max circuit configured to: receive output from the single first configurable nonlinear activation circuit as input, and output a maximum value from the sequential computing circuit.

Clause 7: The processor of any of Clauses 1-6, further comprising a memory buffer configured to buffer output from the sequential computing circuit.

Clause 8: The processor of any of Clauses 1-7, wherein at least one of the first configurable nonlinear activation function circuits is configured to: determine a nonlinear activation function for application to the input data; determine, based on the determined nonlinear activation function, a set of parameters for the nonlinear activation function; and generate output data based on application of the set of parameters for the nonlinear activation function.

Clause 9: The processor of any of Clauses 1-8, wherein at least one of the one or more first configurable nonlinear activation function circuits comprises: a first approximator configured to approximate a first function using one or more first function parameters of the set of parameters; a second approximator configured to approximate a second function using one or more second function parameters of the set of parameters; a gain multiplier configured to multiply a gain value based on one or more gain parameters of the set of parameters; and a constant adder configured to add a constant value based on a constant parameter of the set of parameters.

Clause 10: The processor of any of Clauses 1-9, wherein both the first approximator and the second approximator are cubic approximators.

Clause 11: The processor of any of Clauses 1-10, wherein one of the first approximator or the second approximator is a cubic approximator.

Clause 12: The processor of any of Clauses 1-11, wherein another one of the first approximator or the second approximator is a quadratic approximator or a linear approximator.

Clause 13: The processor of any of Clauses 1-12, wherein another one of the first approximator or the second approximator is configured to access a look-up table for an approximated value.

Clause 14: The processor of any of Clauses 1-13, wherein another one of the first approximator or the second approximator is configured to perform a minimum or maximum function.

Clause 15: The processor of any of Clauses 1-14, wherein: the determined nonlinear activation function comprises an exponential function, the gain parameters comprise a dependent parameter value of 0 and an independent parameter value of 1, the constant value is 0, the first function is bypassed, and the second function is an exponential look-up table.

Clause 16: The processor of any of Clauses 1-15, wherein: the second configurable nonlinear activation function circuit comprises: a first approximator configured to approximate a first function using one or more first function parameters of the set of parameters; a second approximator configured to approximate a second function using one or more second function parameters of the set of parameters; a gain multiplier configured to multiply a gain value based on one or more gain parameters of the set of parameters; and a constant adder configured to add a constant value based on a constant parameter of the set of parameters, the gain parameters comprise a dependent parameter value of 0 and an independent parameter value of 1, the constant value is 0, the first function is bypassed, and the second function is a natural logarithm look-up table.

Clause 17: A method for processing input data by a set of configurable nonlinear activation function circuits, comprising: generating an exponent output by processing input data using one or more first configurable nonlinear activation function circuits configured to perform an exponential function; summing the exponent output of the one or more first configurable nonlinear activation function circuits; and generating an approximated log softmax output by processing the summed exponent output using a second configurable nonlinear activation function circuit configured to perform a natural logarithm function.

Clause 18: The method of Clause 17, further comprising generating an approximated softmax of the input data by processing the approximated log softmax of the input data using the one or more first configurable nonlinear activation function circuits.

Clause 19: The method of any of Clauses 17-18, wherein the one or more first configurable nonlinear activation function circuits comprise a plurality of first configurable nonlinear activation circuits, each associated with a corresponding output element from a parallelized computing array.

Clause 20: The method of any of Clauses 17-19, further comprising: determining a maximum value from the output elements of the parallelized computing array, and providing the maximum value from the output elements to the one or more first configurable nonlinear activation function circuits.

Clause 21: The method of any of Clauses 17-20, wherein the one or more first configurable nonlinear activation function circuits comprise a single first configurable nonlinear activation circuit that receives input data from a sequential computing circuit.

Clause 22: The method of any of Clauses 17-21, further comprising determining a maximum output from the single first configurable nonlinear activation circuit.

Clause 23: The method of any of Clauses 17-22, further comprising buffering output from the sequential computing circuit.

Clause 24: The method of any of Clauses 17-23, further comprising: determining a nonlinear activation function for application to input data; determining, based on the determined nonlinear activation function, a set of parameters for a configurable nonlinear activation function circuit; and processing input data with the configurable nonlinear activation function circuit based on the set of parameters to generate output data

Clause 25: The method of any of Clauses 17-24, further comprising retrieving the set of parameters from a memory based on the determined nonlinear activation function.

Clause 26: The method of any of Clauses 17-25, wherein the set of parameters includes a combination of one or more gain parameters, a constant parameter, and one or more approximation functions to apply to the input data via the configurable nonlinear activation function circuit.

Clause 27: The method of any of Clauses 17-26, wherein at least one of the first configurable nonlinear activation function circuits comprises: a first approximator configured to approximate a first function of the one or more approximation functions; a second approximator configured to approximate a second function of the one or more approximation functions; a first gain multiplier configured to multiply a first gain value based on the one or more gain parameters; and a constant adder configured to add a constant value based on the constant parameter.

Clause 28: The method of any of Clauses 17-27, wherein the at least one of the first configurable nonlinear activation function circuits further comprises: a first bypass configured to bypass the first approximator; a second bypass configured to bypass the second approximator; and an input data bypass configured to bypass the first approximator and to provide the input data to the second approximator.

Clause 29: The method of any of Clauses 17-28, wherein: the determined nonlinear activation function comprises an exponential function, the gain parameters comprise a dependent parameter value of 0 and an independent parameter value of 1, the constant value is 0, the first function is bypassed, and the second function is an exponential look-up table.

Clause 30: The method of any of Clauses 17-29, wherein: the second configurable nonlinear activation function circuit comprises: a first approximator configured to approximate a first function using one or more first function parameters of the set of parameters; a second approximator configured to approximate a second function using one or more second function parameters of the set of parameters; a gain multiplier configured to multiply a gain value based on one or more gain parameters of the set of parameters; and a constant adder configured to add a constant value based on a constant parameter of the set of parameters, the gain parameters comprise a dependent parameter value of 0 and an independent parameter value of 1, the constant value is 0, the first function is bypassed, and the second function is a natural logarithm look-up table.

Clause 31: A processing system, comprising: a memory comprising computer-executable instructions; and one or more processors configured to execute the computer-executable instructions and cause the processing system to perform a method in accordance with any of Clauses 17-30.

Clause 32: A processing system, comprising means for performing a method in accordance with any of Clauses 17-30.

Clause 33: A non-transitory computer-readable medium comprising computer-executable instructions that, when executed by one or more processors of a processing system, cause the processing system to perform a method in accordance with any of Clauses 17-30.

Clause 34: A computer program product embodied on a computer-readable storage medium comprising code for performing a method in accordance with any of Clauses 17-30.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term “connected to”, in the context of sharing electronic signals and data between the elements described herein, may generally mean in data communication between the respective elements that are connected to each other. In some cases, elements may be directly connected to each other, such as via one or more conductive traces, lines, or other conductive carriers capable of carrying signals and/or data between the respective elements that are directly connected to each other. In other cases, elements may be indirectly connected to each other, such as via one or more data busses or similar shared circuitry and/or integrated circuit elements for communicating signals and data between the respective elements that are indirectly connected to each other.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. §112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor, comprising:
one or more first configurable nonlinear activation function circuits configured to perform an exponential function on input data;
a summation circuit configured to receive output data of the one or more first configurable nonlinear activation function circuits; and
a second configurable nonlinear activation function circuit configured to receive output data of the summation circuit, perform a natural logarithm function, and output an approximated log softmax of the input data.

2. The processor of claim 1, wherein the second configurable nonlinear activation function circuit is configured to output the approximated log softmax of the input data during a first cycle, wherein during a second cycle subsequent to the first cycle, the approximated log softmax of the input data is provided as input to the one or more first configurable nonlinear activation function circuits, and wherein the one or more first configurable nonlinear activation function circuits are configured to output an approximated softmax of the input data based on the approximated log softmax of the input data.

3. The processor of claim 1, wherein the one or more first configurable nonlinear activation function circuits comprise a plurality of first configurable nonlinear activation circuits, each associated with a corresponding output element from a parallelized computing array.

4. The processor of claim 3, further comprising a max circuit configured to:
receive output elements from the parallelized computing array as input, and
output a maximum value from the output elements to the one or more first configurable nonlinear activation function circuits.

5. The processor of claim 1, wherein the one or more first configurable nonlinear activation function circuits comprise a single first configurable nonlinear activation circuit configured to receive the input data from a sequential computing circuit.

6. The processor of claim 5, further comprising a max circuit configured to:
receive output from the single first configurable nonlinear activation circuit as input, and
output a maximum value from the sequential computing circuit.

7. The processor of claim 5, further comprising a memory buffer configured to buffer output from the sequential computing circuit.

8. The processor of claim 1, wherein at least one of the first configurable nonlinear activation function circuits is configured to:
determine a nonlinear activation function for application to the input data;
determine, based on the determined nonlinear activation function, a set of parameters for the nonlinear activation function; and
generate output data based on application of the set of parameters for the nonlinear activation function.

9. The processor of claim 8, wherein at least one of the one or more first configurable nonlinear activation function circuits comprises:
a first approximator configured to approximate a first function using one or more first function parameters of the set of parameters;
a second approximator configured to approximate a second function using one or more second function parameters of the set of parameters;
a gain multiplier configured to multiply a gain value based on one or more gain parameters of the set of parameters; and
a constant adder configured to add a constant value based on a constant parameter of the set of parameters.

10. The processor of claim 9, wherein both the first approximator and the second approximator are cubic approximators.

11. The processor of claim 9, wherein one of the first approximator or the second approximator is a cubic approximator.

12. The processor of claim 11, wherein another one of the first approximator or the second approximator is a quadratic approximator or a linear approximator.

13. The processor of claim 11, wherein another one of the first approximator or the second approximator is configured to access a look-up table for an approximated value.

14. The processor of claim 11, wherein another one of the first approximator or the second approximator is configured to perform a minimum or maximum function.

15. The processor of claim 9, wherein:
the determined nonlinear activation function comprises an exponential function,
the gain parameters comprise a dependent parameter value of 0 and an independent parameter value of 1,
the constant value is 0,
the first function is bypassed, and
the second function is an exponential look-up table.

16. The processor of claim 1, wherein:
the second configurable nonlinear activation function circuit comprises:
a first approximator configured to approximate a first function using one or more first function parameters of the set of parameters;
a second approximator configured to approximate a second function using one or more second function parameters of the set of parameters;
a gain multiplier configured to multiply a gain value based on one or more gain parameters of the set of parameters; and
a constant adder configured to add a constant value based on a constant parameter of the set of parameters,
the gain parameters comprise a dependent parameter value of 0 and an independent parameter value of 1,
the constant value is 0,
the first function is bypassed, and
the second function is a natural logarithm look-up table.

17. A method for processing input data by a set of configurable nonlinear activation function circuits, comprising:
generating an exponent output by processing input data using one or more first configurable nonlinear activation function circuits configured to perform an exponential function;
summing the exponent output of the one or more first configurable nonlinear activation function circuits; and
generating an approximated log softmax output by processing the summed exponent output using a second configurable nonlinear activation function circuit configured to perform a natural logarithm function.

18. The method of claim 17, further comprising generating an approximated softmax of the input data by processing the approximated log softmax of the input data using the one or more first configurable nonlinear activation function circuits.

19. The method of claim 17, wherein the one or more first configurable nonlinear activation function circuits comprise a plurality of first configurable nonlinear activation circuits, each associated with a corresponding output element from a parallelized computing array.

20. The method of claim 19, further comprising:
determining a maximum value from the output elements of the parallelized computing array; and
providing the maximum value from the output elements to the one or more first configurable nonlinear activation function circuits.

21. The method of claim 17, wherein the one or more first configurable nonlinear activation function circuits comprise a single first configurable nonlinear activation circuit that receives input data from a sequential computing circuit.

22. The method of claim 21, further comprising determining a maximum output from the single first configurable nonlinear activation circuit.

23. The method of claim 21, further comprising buffering output from the sequential computing circuit.

24. The method of claim 17, further comprising:
determining a nonlinear activation function for application to input data;
determining, based on the determined nonlinear activation function, a set of parameters for a configurable nonlinear activation function circuit; and
processing input data with the configurable nonlinear activation function circuit based on the set of parameters to generate output data.

25. The method of claim 24, further comprising retrieving the set of parameters from a memory based on the determined nonlinear activation function.

26. The method of claim 24, wherein the set of parameters includes a combination of one or more gain parameters, a constant parameter, and one or more approximation functions to apply to the input data via the configurable nonlinear activation function circuit.

27. The method of claim 26, wherein at least one of the first configurable nonlinear activation function circuits comprises:
a first approximator configured to approximate a first function of the one or more approximation functions;
a second approximator configured to approximate a second function of the one or more approximation functions;
a first gain multiplier configured to multiply a first gain value based on the one or more gain parameters; and
a constant adder configured to add a constant value based on the constant parameter.

28. The method of claim 27, wherein the at least one of the first configurable nonlinear activation function circuits further comprises:
a first bypass configured to bypass the first approximator;
a second bypass configured to bypass the second approximator; and
an input data bypass configured to bypass the first approximator and to provide the input data to the second approximator.

29. The method of claim 28, wherein:
the determined nonlinear activation function comprises an exponential function,
the gain parameters comprise a dependent parameter value of 0 and an independent parameter value of 1,
the constant value is 0,
the first function is bypassed, and
the second function is an exponential look-up table.

30. The method of claim 17, wherein:
the second configurable nonlinear activation function circuit comprises:
a first approximator configured to approximate a first function using one or more first function parameters of the set of parameters;
a second approximator configured to approximate a second function using one or more second function parameters of the set of parameters;
a gain multiplier configured to multiply a gain value based on one or more gain parameters of the set of parameters; and
a constant adder configured to add a constant value based on a constant parameter of the set of parameters,
the gain parameters comprise a dependent parameter value of 0 and an independent parameter value of 1,
the constant value is 0,
the first function is bypassed, and
the second function is a natural logarithm look-up table.
